(19) United States
(12) Patent Application Publication
(10) Pub. No.: US 2025/0094125 A1
(43) Pub. Date: Mar. 20, 2025

(54) MULTI-MODE COMPUTE-IN-MEMORY SYSTEMS AND METHODS FOR OPERATING THE SAME

(71) Applicant: Taiwan Semiconductor Manufacturing Company, Ltd., Hsinchu (TW)

(72) Inventors: Win-San Khwa, Hsinchu (TW); Jui-Jen Wu, Hsinchu (TW); Meng-Fan Chang, Hsinchu (TW); Ping-Chun Wu, Hsinchu (TW); Ho-Yu Chen, Hsinchu (TW)

(73) Assignee: Taiwan Semiconductor Manufacturing Company, Ltd., Hsinchu (TW)

(21) Appl. No.: 18/405,913

(22) Filed: Jan. 5, 2024

Related U.S. Application Data
(60) Provisional application No. 63/582,921, filed on Sep. 15, 2023.
(60) Provisional application No. 63/611,413, filed on Dec. 18, 2023.

(51) Int. Cl. G06F 7/499; G06F 7/50

(52) U.S. Cl. CPC G06F 7/49915; G06F 7/50

(57) ABSTRACT

A circuit includes local computing cells. Each of the local computing cells can provide, in response to identifying that the input data elements and weight data elements are in a first data type, a first sum including (i) a first product of a first input data element and a first weight data element; and (ii) a second product of a second input data element and a second weight data element. Each of the local computing cells can provide, in response to identifying that the input data elements and weight data elements are in a second data type, (i) a second sum of a first portion of a third input data element and a first portion of a third weight data element; and (ii) a third product of a second portion of the third input data element and a second portion of the third weight data element.

### CROSS-REFERENCE TO RELATED APPLICATION

This application claims priority to and the benefit of U.S. Provisional Application No. 63/582,921, filed Sep. 15, 2023, and also to U.S. Provisional Patent App. No. 63/611,413, filed Dec. 18, 2023, both of which are incorporated herein by reference in their entireties for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a block diagram of a compute-in-memory circuit, in accordance with some embodiments.

FIG. 2 illustrates a block diagram of a local computing cell of the compute-in-memory circuit of FIG. 1, in accordance with some embodiments.

FIG. 3 illustrates a schematic diagram of the local computing cell of FIG. 2 when operating with an INT8 data type, in accordance with some embodiments.

FIG. 4 illustrates a schematic diagram of the local computing cell of FIG. 2 when operating with an INT4 data type, in accordance with some embodiments.

FIG. 5 illustrates a schematic diagram of the local computing cell of FIG. 2 when operating with a BF16 data type, in accordance with some embodiments.

FIG. 6 illustrates a schematic diagram of a portion of an input circuit of the compute-in-memory circuit of FIG. 1 when operating with an INT8 data type, in accordance with some embodiments.

FIG. 7 illustrates a schematic diagram of a portion of an input circuit of the compute-in-memory circuit of FIG. 1 when operating with an INT4 data type, in accordance with some embodiments.

FIG. 8 illustrates a schematic diagram of a portion of an input circuit of the compute-in-memory circuit of FIG. 1 when operating with a BF16 data type, in accordance with some embodiments.

FIG. 9 illustrates a table summarizing various operation modes of local computing cell of FIG. 2, in accordance with some embodiments.

FIG. 10 illustrates a schematic diagrams of a portion of the compute-in-memory circuit of FIG. 1 when operating with an INT8 data type, in accordance with some embodiments.

FIG. 11 illustrates a schematic diagrams of a portion of the compute-in-memory circuit of FIG. 1 when operating with an INT4 data type, in accordance with some embodiments.

FIG. 12 illustrates a schematic diagrams of a portion of the compute-in-memory circuit of FIG. 1 when operating with a BF16 data type, in accordance with some embodiments.

FIGS. 13 and 14 collectively illustrate an example where the compute-in-memory circuit of FIG. 1 operates with a FP16 data type, in accordance with some embodiments.

FIG. 15 is an example flow chart of a method for operating a compute-in-memory circuit, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, compute-in-memory (CIM) circuits or systems have been proposed to perform such MAC operations. Similar to a human brain, a CIM circuit instead conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

The data elements, processed by the CIM circuit, have various data types or forms, such as an integer data type and a floating point data type. The integer data types, each of which represents a range of mathematical integers, may be of different sizes. For example, the integer data types are of 4 bits (sometimes referred to as an INT4 data type), 8 bits (sometimes referred to as an INT8 data type), etc. The floating point data type is typically represented by a sign portion, an exponent portion, and a significand (mantissa) portion that consists of the significant digits of the number. For example, one floating point number format specified by the Institute of Electrical and Electronics Engineers (IEEE®) has sixteen bits in size (sometimes referred to as an FP16 data type), which includes ten mantissa bits, five exponent bits, and one sign bit. Another floating point number format also has sixteen bits in size (sometimes referred to as a BF16 data type), which includes seven mantissa bits, eight exponent bits, and one sign bit.

In machine learning applications, the CIM circuit is frequently configured to process dot product multiplications based on performing MAC operations on a large number of data elements (e.g., an input word vector and a weight matrix), which may each be in the integer data type or the floating point data type, and then process addition (or accumulation) of such dot products. However, in the existing technologies, nearly no CIM circuit has been configured to process data elements in both of the integer data type and the floating point data type. For example, dedicated hardware circuit components are generally needed for processing different data types, which disadvantageously lowers the hardware utilization rate. In turn, such CIM circuits may occupy an additional portion of the precious real estate of a substrate. Thus, the existing CIM circuits have not been entirely satisfactory in certain aspects.

The present disclosure provides various embodiments of a compute-in-memory (CIM) circuit that can switch between a first mode and a second mode, in which the first mode is configured for processing a number of input data elements and a corresponding number weight data elements that are each provided as an integer data type, and the second mode is configured for processing a number of input data elements and a corresponding number weight data elements that are each provided as a floating point data type. For example, the CIM circuit, as disclosed herein, can perform in-memory computations (e.g., multiply-accumulate (MAC) operations) on the input data elements and the weight data elements. Based on whether the input/weight data elements are provided as the integer or floating point data type, the CIM circuit can use the same hardware components to perform the MAC operations. In various embodiments, the disclosed CIM circuit may include a number of multi-mode local computing cells (LCCs). Based on the data type received or identified, each of the LCCs can selectively perform MAC operations on a pair of weight data elements and a pair of input data elements (when, e.g., each of the input/weight data elements is provided with the INT8 data type), a quadruple of weight data elements and a quadruple of input data elements (when, e.g., each of the input/weight data elements provided with the INT4 data type), or a single weight data element and a single input data element (when, e.g., each of the input/weight data elements is provided with the FP16 or BF16 data type).

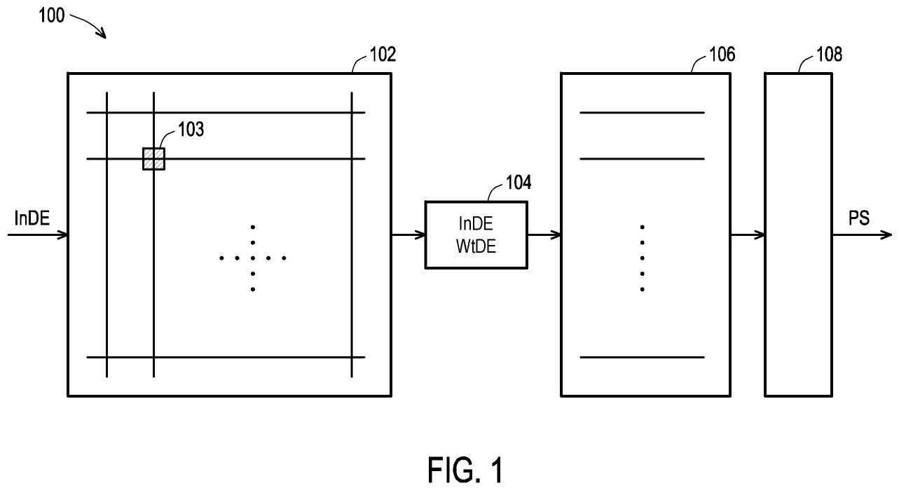

FIG. 1 illustrates a block diagram of a data computation circuit 100, in accordance with various embodiments of the present disclosure. In the illustrated embodiment depicted in FIG. 1, the data computation circuit 100, also referred to as circuit 100 or memory circuit 100, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (N) of weight data elements WtDE. In some embodiments, each of the input data elements InDE and the weight data elements WtDE may be configured or provided in the INT8 data type. In some embodiments, each of the input data elements InDE and the weight data elements WtDE may be configured or provided in the INT4 data type. In some embodiments, each of the input data elements InDE and the weight data elements WtDE may be configured or provided in the FP16 data type. In some embodiments, each of the input data elements InDE and the weight data elements WtDE may be configured or provided in the BF16 data type.

As shown, the memory circuit 100 includes a memory circuit 102, an input circuit 104, a number of local computing cells 106, and an adder circuit (or adder tree) 108. Each of the components shown in FIG. 1 (e.g., 102 to 108) is an electronic circuit including logic circuitry configured to perform a respective function. In some embodiments, the number of local computing cells 106 may correspond to the number of input data elements InDE and the weight data elements WtDE. For example, the memory circuit 100 may include, receive, obtain, or otherwise process N weight/input data elements WtDE/InDE, and the number of (e.g., active) local computing cells 106 may be N/2, N/4, or N, depending on the data type of the weight/input data elements WtDE/InDE being provided or identified. It should be appreciated that the block diagram of the circuit depicted in FIG. 1 is simplified, and thus, the memory circuit 100 can include any of various other components while remaining within the scope of the present disclosure.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 so as to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements WtDE. In some embodiments, the programming circuits may write the weight data elements WtDE into corresponding storage elements 103 of the memory arrays, respectively, while the reading circuit may read bits written into the storage elements 103, so as to verify or otherwise test whether the written weight data elements WtDE are correct. The drivers of the memory circuit 102 can include or be operatively coupled to a number of input activation latches that are configured to receive and temporarily store the input data elements InDE. In some other embodiments, such input activation latches may be part of the input circuit 104, which can further include a number of buffers that are configured to temporarily store the weight data elements WtDE retrieved from the memory arrays of the memory circuit 102. As such, the input circuit 104 can receive the input data elements InDE and the weight data elements WtDE.

In some embodiments, the input word vector (including, e.g., the input data elements InDE) and the weight matrix (including, e.g., the weight data elements WtDE), on which the memory circuit 100 is configured to perform MAC operations, can be configured in any of at least the following data types: the INT8 data type, the INT4 data type, the FP16 data type, and the BF16 data type. However, it should be understood that. In some other embodiments, each of the input data elements InDE and the weight data elements WtDE can have any of various other integer or floating point data types such as, for example, an INT16 data type, a FP32 data type, a FP64 data type, a FP128 data type, etc., while remaining within the scope of the present disclosure.

When configured as the INT8 data type, each of the input data elements InDE and weight data elements WtDE includes 8 bits. When configured as the INT4 data type, each of the input data elements InDE and weight data elements WtDE includes 4 bits. When configured as the FP16 data type, each of the input data elements InDE and weight data elements WtDE includes 1 sign bit, 5 exponent bits, and 10 mantissa bits. When configured as the BF16 data type, each of the input data elements InDE and weight data elements WtDE includes 1 sign bit, 8 exponent bits, and 7 mantissa bits.

Referring still to FIG. 1, the input circuit 104 is configured to output entireties of the input data elements InDE and the weight data elements WtDE to the local computing cells 106. When configured in the INT8 data type, the input circuit 104 is configured to output a pair of the input data elements InDE and a pair of the weight data elements WtDE to a corresponding one of the local computing cells 106. When configured in the INT4 data type, the input circuit 104 is configured to output a quadruple of the input data elements InDE and a quadruple of the weight data elements WtDE to a corresponding one of the local computing cells 106. When configured in the BF16 or FP16 data type, the input circuit 104 is configured to output a single one of the input data elements InDE and a single one of the weight data elements WtDE to a corresponding one of the local computing cells 106.

In response to identifying that the input data elements InDE and weight data elements WtDE are provided as an integer data type (e.g., the INT8 data type), each of the local computing cells 106 can provide one multiply-accumulate (MAC) result of the corresponding pair of the input data elements InDE and weight data elements WtDE. Such a MAC result is a sum of (i) a product of a first one of the input data elements InDE (e.g., IN₀) and a first one of the weight data elements WtDE (e.g., W₀); and (ii) a product of a second one of the input data elements InDE (e.g., IN₁) and a second one of the weight data elements WtDE (e.g., W₁).

The MAC result may be an accumulated sum of multiple partial MAC results, each of which represents a sum of (i) a product of a corresponding bit of the first input data element InDE and the first weight data element WtDE (e.g., IN₀×W₀); and (ii) a product of a corresponding bit of the second input data element InDE and the second weight data element WtDE (e.g., IN₁×W₁).

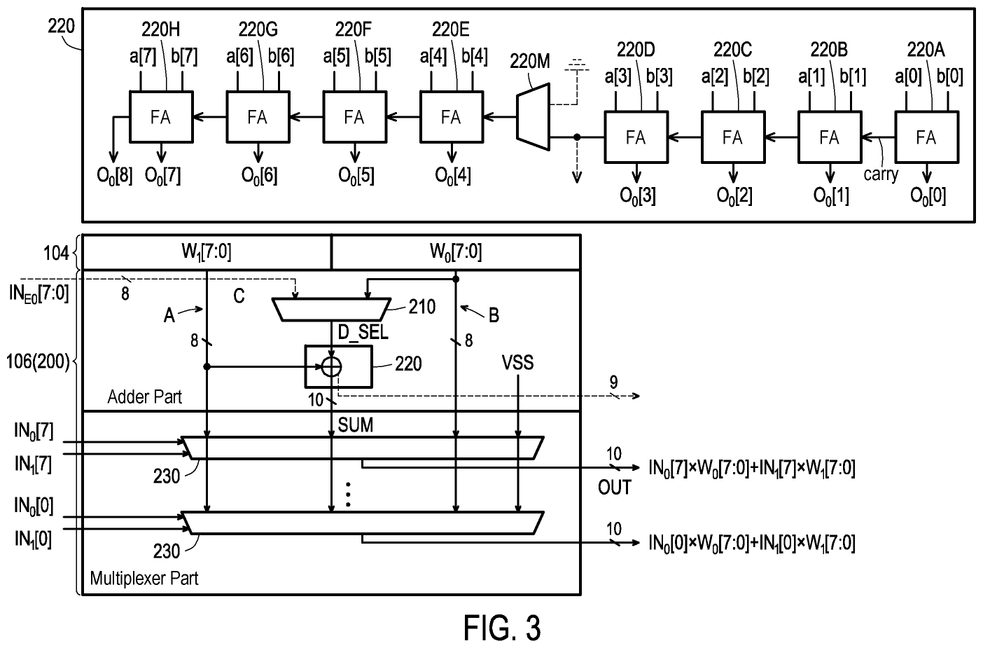

Further, each of the local computing cell 106 can include a first part and a second part that are generally referred to as an adder part and a multiplexer part, respectively. In response to identifying the data type of the input/weight data elements, the first part can sum the pair of weight data elements WtDE and provide it to the second part, causing the second part to calculate the MAC result based on a logic combination of the pair of input data elements InDE, which will be discussed in further detail with respect to FIG. 3.

In response to identifying that the input data elements InDE and weight data elements WtDE are provided as another integer data type (e.g., the INT4 data type), each of the local computing cells 106 can provide four MAC results of the corresponding quadruple of the input data elements InDE and weight data elements WtDE. A first one of the MAC results is a sum of (i) a product of a first one of the input data elements InDE (e.g., IN₀) and a first one of the weight data elements WtDE (e.g., W₀); and (ii) a product of a second of the input data elements InDE (e.g., IN₂) and a second one of the weight data elements WtDE (e.g., W₂). A second one of the MAC results is a sum of (i) a product of the first input data element InDE and a third one of the weight data elements WtDE (e.g., W₁); and (ii) a product of the second input data element InDE and a fourth one of the weight data elements WtDE (e.g., W₃). A third one of the MAC results is a sum of (i) a product of a third one of the input data elements InDE (e.g., IN₁) and the first weight data element WtDE; and (ii) a product of a fourth of the input data elements InDE (e.g., IN₃) and the second weight data element WtDE. A fourth one of the MAC results is a sum of (i) a product of the third input data element InDE and the third weight data element WtDE; and (ii) a product of the fourth input data element InDE and the fourth weight data element WtDE.

The MAC result may be an accumulated sum of multiple partial MAC results, each of which represents a sum of (i) a product of a corresponding bit of the first/third input data element InDE and the first/third weight data element WtDE (e.g., IN₀×W₀, IN₀×W₁, IN₁×W₀, IN₁×W₁); and (ii) a product of a corresponding bit of the second/fourth input data element InDE and the second/fourth weight data element (e.g., IN₂×W₂, IN₂×W₃, IN₃×W₂, IN₃×W₃).

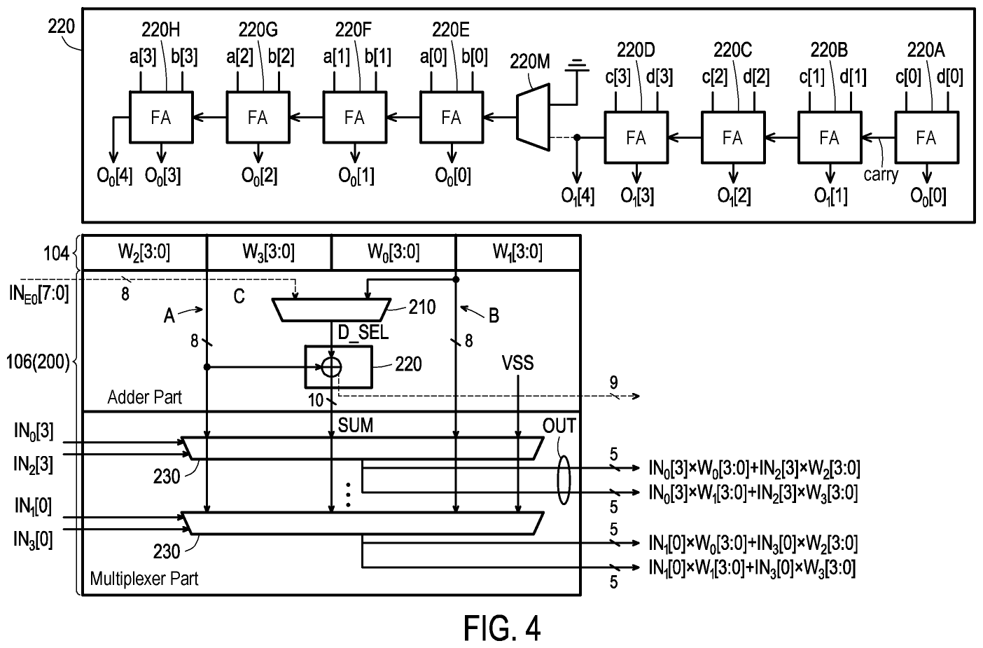

Further, each of the local computing cell 106 can include a first part and a second part that are generally referred to as an adder part and a multiplexer part, respectively. In response to identifying the data type of the input/weight data elements, the the first part can sum the second and fourth weight data elements WtDE, sum the first and third weight data elements WtDE, and provide them to the second part, causing the second part to calculate the MAC results based on a logic combination of the first and second input data elements InDE and a logic combination of the third and fourth input data elements InDE, which will be discussed in further detail with respect to FIG. 4.

In response to identifying that the input data elements InDE and weight data elements WtDE are provided as a floating point data type (e.g., the BF16 data type), each of the local computing cells 106 can provide a pair of MAC elements of the corresponding input data element InDE and the corresponding weight data element WtDE. Such MAC elements include: (i) a sum of an exponent portion of the input data element InDE (e.g., IN_{E0}) and an exponent portion of the weight data element (e.g., W_{E0}); and (ii) a product of a mantissa portion of the input data element InDE (e.g., IN_{M0}) and a mantissa portion of the weight data element WtDE (e.g., W_{M0}).

The MAC element (e.g., the mantissa product) may be an accumulated sum of multiple partial mantissa products, each of which represents a product of a corresponding bit of the mantissa portion of the input data element InDE and the mantissa portion of the weight data element WtDE (e.g., IN_{M0}×W_{M0}).

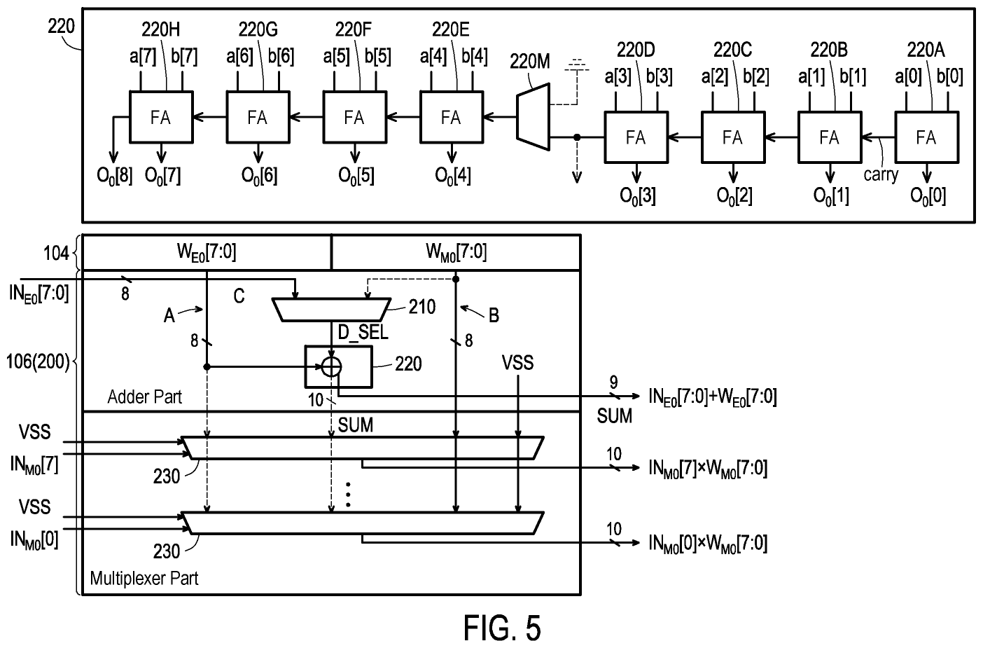

Further, each of the local computing cell 106 can include a first part and a second part that are generally referred to as an adder part and a multiplexer part, respectively. In response to identifying the data type of the input/weight data elements, the first part can provide the sum of the exponent portions, and the second part can provide the product of the mantissa portions, which will be discussed in further detail below with respect to FIG. 5.

The adder tree 108 can receive the MAC results/elements from all of the local computing cells 106, and sum them up to generate a final MAC result (PS) of the N input data elements InDE and the N weight data elements WtDE. For example, in response to identifying that a data type of the input/weight data elements is the INT8, the adder tree 108 can sum the N/2 MAC results provided by the local computing cells 106, respectively, and provide the PS result through one output channel. In another example, in response to identifying that a data type of the input/weight data elements is the INT4, the adder tree 108 can sum the N/4 MAC results provided by the local computing cells 106, respectively, and provide the PS result through four output channels. In yet another example, in response to identifying that a data type of the input/weight data elements is the BF16, the adder tree 108 can sum the N MAC elements (mantissa products) provided by the local computing cells 106, respectively, and provide the PS result through one output channel.

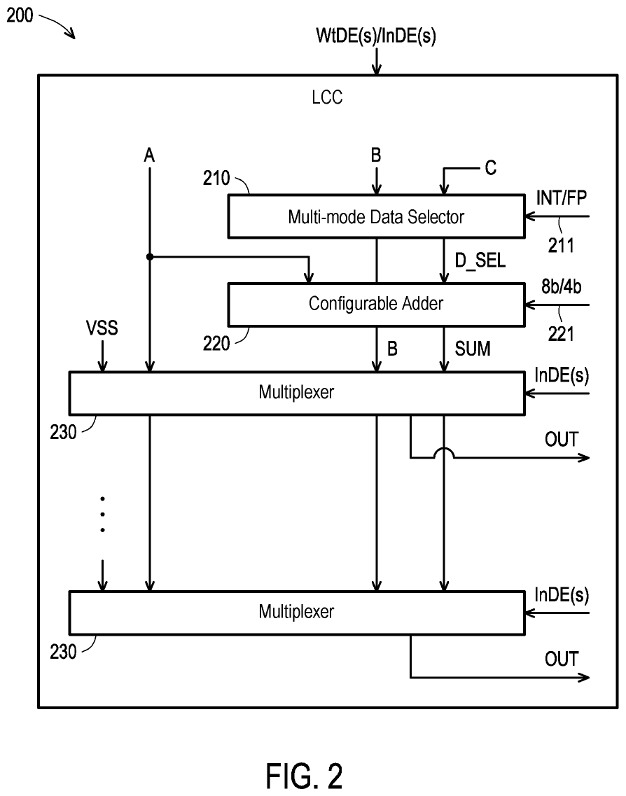

FIG. 2 illustrates a block diagram 200 of the local computing cell 106 (hereinafter “local computing cell 200”), in accordance with various embodiments of the present disclosure. In brief overview, the local computing cell 200 is configured to receive one or more of the input data elements InDE and a corresponding number of the weight data elements WtDE (e.g., from the input circuit 104 of FIG. 1), and provide one or more MAC results or MAC elements to an adder tree (e.g., 108). It should be appreciated that the block diagram of the local computing cell 200 depicted in FIG. 2 is simplified, and thus, the local computing cell 200 can include any of various other components while remaining within the scope of the present disclosure.

As shown, the local computing cell 200 includes a multi-mode data selector 210, a configurable adder 220, and a number of multiplexers (MUXs) 230. In various embodiments of the present disclosure, regardless of the data type of the input data elements InDE and weight data elements WtDE being received, the local computing cell 200 can use the same hardware components, e.g., 210-230, to process the corresponding input data element(s) InDE and weight data element(s) WtDE and provide the MAC result(s)/element(s). For example, based on the identified data types, the components 210 to 230 can respond differently (or operated in different modes) to provide respective outputs. Accordingly, each of the hardware components of the local computing cell 200 will be introduced as follows, and will be further described when operating under different modes in FIGS. 3, 4, and 5, respectively.

In some embodiments, the local computing cell 200 can process MAC operations on data elements of 16 bits each time (e.g., each clock cycle or each time duration). For example, the local computing cell 200 can perform MAC operations on 2 input data elements InDE and 2 weight data elements WtDE, each of which has 8 bits. In another example, the local computing cell 200 can perform MAC operations on 4 input data elements InDE and 4 weight data elements WtDE, each of which has 4 bits. In yet another example, the local computing cell 200 can perform MAC operations on 1 input data element InDE and 1 weight data element WtDE, each of which has 16 bits. However, the local computing cell 200 can process other number of bits while remaining within the scope of the present disclosure. Further, the number of the multiplexers 230 of each local computing cell 200 may correspond to the number of processed bits. For example, the number of multiplexers 230 may be equal to one half of the number of processed bits.

Upon receiving the input data elements InDE and weight data elements WtDE, the local computing cell 200 can separate the weight data elements WtDE into a signal A and a signal B. When the data elements are in the INT8 data type, the signal B and the signal A may represent a first weight data element WtDE (e.g., W₀) and a second weight data element WtDE (e.g., W₁), respectively. Further, in the example where the data elements each have 16 bits, the signal B may have 8 bits, which may be expressed as W₀[0:7], and the signal A may also have 8 bits, which may be expressed as W₁[0:7]. When the data elements are in the INT4 data type, the signal B may represent first and second weight data elements WtDE (e.g., W₀ and W₁), and the signal A may represent third and fourth weight data elements WtDE (e.g., W₂ and W₃). In the same example where the data elements each have 16 bits, the signal B may have a total of 8 bits, which may be expressed as W₀[0:3] and W₁[0:3], and the signal A may also have 8 bits, which may be expressed as W₂[0:7] and W₃[0:3]. When the data elements are in the BF16 data type, the signal B and the signal A may represent the mantissa portion of a weight data input WtDE (e.g., W_{M0}) and the exponent portion of the weight data input WtDE (e.g., W_{E0}), respectively. Still with the example where the data elements each have 16 bits, the signal B may have 8 bits, which may be expressed as W_{M0}[7:0], and the signal A may also have 8 bits, which may be expressed as W_{E0}[7:0].

The multi-mode data selector 210 can receive the signal B and a signal C (which represents the exponent portion of an input data element InDE, e.g., IN_{E0}), and select one of them as its output based on a control signal 211. In the 16-bit example, the signal C (e.g., IN_{E0}) may also have 8 bits, when the data elements are provided in the BF16 data type, which may be expressed as IN_{E0}[7:0]. The control signal 211 may be generated based on identifying the data type of the input data elements InDE and weight data elements WtDE. For example, when the data type is an integer type (e.g., the INT8 data type, the INT4 data type), the control signal 211 may be indicated as “INT,” which causes the multi-mode data selector 210 to select the signal B; and when the data type is a floating point type (e.g., the FP16 data type, the BF16 data type), the control signal 211 may be indicated as “FP,” which causes the multi-mode data selector 210 to select the signal C. The multi-mode data selector 210 can provide the selected signal as a D_SEL signal (e.g., either the signal B or C) to the configurable adder 220. Continuing with the 16-bit example, the multi-mode data selector 210 may include an 8-bit 2-to-1 multiplexer.

The configurable adder 220 can sum the signal A and the D_SEL signal, and output the result as a signal SUM. Continuing with the 16-bit example, the signal SUM may have 10 bits. In some embodiments, the configurable adder 220 may have a number (e.g., 8) of full adders that can be configured differently based on a control signal 221. The control signal 221 may be generated based on identifying the data type of the input data elements InDE and weight data elements WtDE. For example, when the data elements are identified as the INT8 data type, the control signal 221 may be indicated as “8b,” which causes all 8 full adders to sum the 8-bit signal A (e.g., W₁[7:0]) and the 8-bit D_SEL signal (e.g., W₀[7:0]). As such, the signal SUM can represent W₀[7:0]+W₁[7:0]. In another example, when the data elements are identified as the INT4 data type, the control signal 221 may be indicated as “4b,” which causes first 4 of the 8 full adders to sum a first half of the 8-bit signal A (e.g., W₂[3:0]) and a first half of the 8-bit D_SEL signal (e.g., W₀[3:0]), and second 4 of the 8 full adders to sum a second half of the 8-bit signal A (e.g., W₃[3:0]) and a second half of the 8-bit D_SEL signal (e.g., W₁[3:0]). As such, the signal SUM can represent W₀[3:0]+W₂[3:0] and W₁[3:0]+W₃[3:0]. In yet another example, when the data elements are identified as the BF16 data type, the control signal 221 may be indicated as “X,” which causes all 8 full adders to sum the 8-bit signal A (e.g., WE[7:0]) and the 8-bit D_SEL signal (e.g., IN_{E0}[7:0]). As such, the signal SUM can represent W_{E0}[7:0]+IN_{E0}[7:0], which is sometimes referred to as an exponent sum.

Each of the multiplexers 230 can select one of the signal A, the signal B, the signal SUM, or a fixed voltage (e.g., VSS/ground) based on a number of corresponding bits of the input data elements InDE. Such bits to control the multiplexers 230 may sometimes be referred to as MUX control bits. In some embodiments, each of the multiplexers 230 is configured to receive 2 MUX control bits, at least one of which corresponds to the corresponding input data element InDE or to a mantissa portion of the corresponding input data element InDE. Based on the MUX control bits, the multiplexers 230 can each provide an output signal. For example, based on different logic combinations of these 2 MUX control bits, each of the multiplexers 230 can provide a respective output signal that is a logically processed version of the signal A, the signal B, the signal SUM, or VSS. The term “logically processed version” may refer to a signal having each of its terms/components multiplied by a corresponding logical value (e.g., either 0 or 1).

In the example where the data elements InDE/WtDE are provided in the INT8 data type, the input data elements InDE, received by the local computing cell 200, may consist of a first input data element (e.g., IN₀) and a second input data element (e.g., IN₁). The first and second input data elements (e.g., IN₀ and IN₁) each have 8 bits, and may be respectively expressed as IN₀[7:0] and IN₁[7:0].

In some embodiments, the 2 MUX control bits, received by each of the multiplexers 230, may consist of a corresponding one of the 8 bits of the IN₀ (e.g., IN₀[7]) and a corresponding one of the 8 bits of the IN₁ (e.g., IN₁[7]), respectively. For example, a first one of the multiplexers 230 can receive IN₀[7] and IN₁[7] as its 2 MUX control bits, respectively; a second one of the multiplexers 230 can receive IN₀[6] and IN₁[6] as its 2 MUX control bits, respectively; a third one of the multiplexers 230 can receive IN₀[5] and IN₁[5] as its 2 MUX control bits, respectively; a fourth one of the multiplexers 230 can receive IN₀[4] and IN₁[4] as its 2 MUX control bits, respectively; a fifth one of the multiplexers 230 can receive IN₀[3] and IN₁[3] as its 2 MUX control bits, respectively; a sixth one of the multiplexers 230 can receive IN₀[2] and IN₁[2] as its 2 MUX control bits, respectively; a seventh one of the multiplexers 230 can receive IN₀[1] and IN₁[1] as its 2 MUX control bits, respectively; and an eighth one of the multiplexers 230 can receive IN₀[0] and IN₁[0] as its 2 MUX control bits, respectively.

Upon receiving the signal A (e.g., W₁), signal B (e.g., W₀), signal SUM (e.g., W₀+W₁), and VSS, each of the multiplexers 230 is configured to select one of these signals and output a signal OUT through multiplying the selected signal by the MUX control bits (e.g., a partial MAC result). The signal OUT may have 10 bits. For example, each of the multiplexers 230 is configured to derive a first product through multiplying the signal B by the corresponding first MUX control bit (e.g., W₀[7:0]×IN₀[7]) and a second product through multiplying the signal A by the corresponding second MUX control bit (e.g., e.g., W₁[7:0]×IN₁[7]), and then sum up the first product and the second product as the signal OUT.

Stated another way, each of the multiplexers 230 can provide a partial MAC result derived based on the corresponding MUX control bits of the input data elements InDE received by the local computing cell 200, and either 0 (VSS), the signal A, the signal B, or the signal SUM. Based on this principle, the multiplexers 230 of the local computing cell 200 receiving the input data elements InDE, IN₀[7:0] and IN₁[7:0], can provide the partial MAC results, W₀[7:0]×IN₀[7]+W₁[7:0]×IN₁[7], W₀[7:0]×IN₀[6]+W₁[7:0]×IN₁[6], W₀[7:0]×IN₀[5]+W₁[7:0]×IN₁[5], W₀[7:0]×IN₀[4]+W₁[7:0]×IN₁[4], W₀[7:0]×IN₀[3]+W₁[7:0]×IN₁[3], W₀[7:0]×IN₀[2]+W₁[7:0]×IN₁[2], W₀[7:0]×IN₀[1]+W₁[7:0]×IN₁[1], and W₀[7:0]×IN₀[0]+W₁[7:0]×IN₁[0], respectively.

In the example where the data elements InDE/WtDE are provided in the INT4 data type, the input data elements InDE, received by the local computing cell 200, may consist of a first input data element (e.g., IN₀), a second input data element (e.g., IN₁), a third input data element (e.g., IN₂), and a fourth input data element (e.g., IN₃). The first to fourth input data elements (e.g., IN₀, IN₁, IN₂, and IN₃) each have 4 bits, and may be respectively expressed as IN₀ [3:0], IN₁[3:0], IN₂[3:0], and IN₃[3:0].

In some embodiments, the multiplexers 230 may be grouped into a plural number of pairs, each of the pairs can correspond to a corresponding bit of the first to fourth input data elements, IN₀, IN₁, IN₂, and IN₃. Accordingly, the 2 MUX control bits, received by a first one of a first multiplexer pair 230, may consist of one of the 4 bits of the IN₀ (e.g., IN₀[3]) and one of the 4 bits of the IN₂ (e.g., IN₂[3]), respectively; and the 2 MUX control bits, received by a second one of the first multiplexer pair 230, may consist of one of the 4 bits of the IN₁ (e.g., IN₁[3]) and one of the 4 bits of the IN₃ (e.g., IN₃[3]), respectively. Similarly, the 2 MUX control bits, received by a first one of a second multiplexer pair 230, may consist of one of the 4 bits of the IN₀ (e.g., IN₀[2]) and one of the 4 bits of the IN₂ (e.g., IN₂[2]), respectively; and the 2 MUX control bits, received by a second one of the second multiplexer pair 230, may consist of one of the 4 bits of the IN₁ (e.g., IN₁[2]) and one of the 4 bits of the IN₃ (e.g., IN₃[2]), respectively; and so on. Upon receiving the signal A (e.g., W₁ and W₃), signal B (e.g., W₀ and W₂), signal SUM (e.g., W₀+W₁, W₂+W₃), and VSS, each of the multiplexers 230 is configured to select one of these signals and output a signal OUT through multiplying the selected signal by the MUX control bits (e.g., two partial MAC results). The signal OUT may have 10 bits.

For example, the first one of the multiplexer pair 230 is configured to derive a first product through multiplying the signal B by the corresponding first MUX control bit (e.g., W₀[3:0]×IN₀[3]) and a second product through multiplying the signal A by the corresponding second MUX control bit (e.g., W₂[3:0]×IN₂[3]), and then sum up the first product and the second product as a first sum (e.g., a first partial MAC result). Further, the first one of the multiplexer pair 230 is configured to derive a third product through multiplying the signal A by the corresponding first MUX control bit (e.g., W₁[3:0]×IN₀[3]) and a fourth product through multiplying the signal B by the corresponding second MUX control bit (e.g., W₃[3:0]×IN₂[3]), and then sum up the third product and the fourth product as a second sum (e.g., a second partial MAC result). The first one of the multiplexer pair 230 can then provide the first sum and the second sum as its signal OUT. Similarly, the second one of the multiplexer pair 230 can provide a corresponding signal OUT through multiplying the signal A, B, SUM, or VSS by the MUX control bits. Continuing with the same example, the second one of the multiplexer pair 230 can provide a first sum (e.g., W₀[3:0]×IN₁[3]+W₂[3:0]×IN₃[3]) and a second sum (e.g., W₁[3:0]×IN₁[3]+W₃[3:0]×IN₃[3]) as its signal OUT.

Stated another way, each of the multiplexers 230 can provide a first partial MAC result and a second partial MAC result derived based on the corresponding MUX control bits of two of the input data elements InDE (e.g., IN₀, IN₁, IN₂, and IN₃) received by the local computing cell 200, and either 0 (VSS), the signal A, the signal B, or the signal SUM. The multiplexers 230 of each local computing cell 200 can be grouped to a number of multiplexer pairs 230. Specifically, one multiplexer of each multiplexer pair 230 can provide a first pair of partial MAC results based on the input data elements, IN₀ and IN₂, and the other multiplexer of each multiplexer pair 230 can provide a second pair of partial MAC results based on the input data elements, IN₁ and IN₃. As a non-limiting example, one of the multiplexer pair 230 receiving the input data elements, IN₀[3] and IN₂[3], as its MUX control bits can provide the partial MAC results as W₀[3:0]×IN₀[3]+W₂[3:0]×IN₂[3] and W₁[3:0]×IN₀[3]+W₃[3:0]×IN₂[3]; and the other of the multiplexer pair 230 receiving the input data elements, IN₁[3] and IN₃[3], as its MUX control bits can provide the partial MAC results as W₀[3:0]×IN₁[3]+W₂[3:0]×IN₃[3] and W₁[3:0]×IN₁[3]+W₃[3:0]×IN₃[3].

Based on this principle, the multiplexers 230 of the local computing cell 200 receiving the input data elements, IN₀[2] and IN₂[2], can provide the partial MAC results as W₀[3:0]×IN₀[2]+W₂[3:0]×IN₂[2] and W₁[3:0]×IN₀[2]+W₃[3:0]×IN₂[2]; and the multiplexers 230 of the local computing cell 200 receiving the input data elements, IN₁[2] and IN₃[2], can provide the partial MAC results as W₀[3:0]×IN₁[2]+W₂[3:0]×IN₃[2] and W₁[3:0]×IN₁[2]+W₃[3:0]×IN₃[2]. The multiplexers 230 of the local computing cell 200 receiving the input data elements, IN₀[1] and IN₂[1], can provide the partial MAC results as W₀[3:0]×IN₀[1]+W₂[3:0]×IN₂[1] and W₁[3:0]×IN₀[1]+W₃[3:0]×IN₂[1]; and the multiplexers 230 of the local computing cell 200 receiving the input data elements, IN₁[1] and IN₃[1], can provide the partial MAC results as W₀[3:0]×IN₁[1]+W₂[3:0]×IN₃[1] and W₁[3:0]×IN₁[1]+W₃[3:0]×IN₃[1]. The multiplexers 230 of the local computing cell 200 receiving the input data elements, IN₀[0] and IN₂[0], can provide the partial MAC results as W₀[3:0]×IN₀[0]+W₂[3:0]×IN₂[0] and W₁[3:0]×IN₀[0]+W₃[3:0]×IN₂[0]; and the multiplexers 230 of the local computing cell 200 receiving the input data elements, IN₁[0] and IN₃[0], can provide the partial MAC results as W₀[3:0]×IN₁[0]+W₂[3:0]×IN₃[0] and W₁[3:0]×IN₁[0]+W₃[3:0]×IN₃[1].

In the example where the data elements InDE/WtDE are provided in the BF16 data type, the input data elements InDE, received by the local computing cell 200, may consist of one input data element (e.g., IN₀). The input data element (e.g., IN₀) may have 16 bits, 8 of which represent a mantissa portion of the input data element (e.g., IN_{M0}[7:0]). Further, the multiplexers 230 of the local computing cell 200 may each receive a corresponding bit of the mantissa portion of the input data element (e.g., one of the IN_{M0}[7:0]) as a first one of its 2 MUX control bits. Each of the multiplexers 230 can receive VSS as a second one of the 2 MUX control bits. For example, a first one of the multiplexers 230 can receive IN_{M0}[7] as one of its 2 MUX control bits; a second one of the multiplexers 230 can receive IN_{M0}[6] as one of its 2 MUX control bits; a third one of the multiplexers 230 can receive IN_{M0}[5] as one of its 2 MUX control bits; a fourth one of the multiplexers 230 can receive IN_{M0}[4] as one of its 2 MUX control bits; a fifth one of the multiplexers 230 can receive IN_{M0}[³] as one of its 2 MUX control bits; a sixth one of the multiplexers 230 can receive IN_{M0}[2] as one of its 2 MUX control bits; a seventh one of the multiplexers 230 can receive IN_{M0}[1] as one of its 2 MUX control bits; and an eighth one of the multiplexers 230 can receive IN_{M0}[0] as one of its 2 MUX control bits.

Upon receiving the signal B (e.g., W_{M0}) and VSS, each of the multiplexers 230 is configured to provide a signal OUT (as, e.g., an MAC element) through multiplying the signal B by the MUX control bits. The signal OUT may have 10 bits. For example, each of the multiplexers 230 is configured to derive a product through multiplying the signal B by the corresponding first MUX control bit (e.g., W_{M0}[7:0]×IN_{M0}[7]), and then output the product as the signal OUT. Stated another way, each of the multiplexers 230 can provide an MAC element derived based on the corresponding first MUX control bit of the input data elements InDE received by the local computing cell 200 and VSS. Based on this principle, the multiplexers 230 of the local computing cell 200 receiving the mantissa portions of the input data elements, IN_{M0}[7:0], can provide the MAC elements, W_{M0}[7:0]×IN_{M0}[7], W_{M0}[7:0]×IN_{M0}[6], W_{M0}[7:0]×IN_{M0}[5], W_{M0}[7:0]×IN_{M0}[4], W_{M0}[7:0]×IN_{M0}[3], W_{M0}[7:0]×IN_{M0}[2], W_{M0}[7:0]×IN_{M0}[1], and W_{M0}[7:0]×IN_{M0}[0], respectively. These MAC elements (sometimes referred to as mantissa products) can be shifted by aligning their respective exponent sums (W_{E0}[7:0]+IN_{E0}[7:0]) with a maximum one of the exponent sums. Next, such shifted MAC elements can be summed, with an exponent of the maximum exponent sum, to provide a MAC result.

Referring first to FIG. 3, a schematic diagram of one of the local computing cells 106 of the memory circuit 100 (that is implemented as the local computing cell 200 in FIG. 2) is shown, when the data elements are received or identified as the INT8 data type, in accordance with some embodiments. In the illustrative example of FIG. 3, the local computing cell 106 is coupled to the input circuit 104 to receive a pair of the input data elements InDE, each of which has 8 bits, e.g., IN₀[7:0] and IN₁[7:0], and receive a pair of the weight data elements WtDE, each of which has 8 bits, e.g., W₀[7:0] and W₁[7:0]. Accordingly, it should be appreciated that other local computing cells 106 of the memory circuit 100 can each receive a corresponding pair of the input data elements InDE, e.g., IN₂[7:0] and IN₃[7:0], etc., and a corresponding pair of the weight data elements WtDE, e.g., W₂[7:0] and W₃[7:0], etc.

As shown, the local computing cell 106 can receive the W₀[7:0] and W₁[7:0] as the signal B and the signal A, respectively. The multi-mode data selector 210 can select the signal B and output it as the D_SEL signal (e.g., 8 bits) to the configurable adder 220. The configurable adder 220 can also receive the signal A, and sum the signal A and the D_SEL signal as the signal SUM which may have 10 bits. Each of the multiplexers 230 can receive the signal A, the signal B, the signal SUM, and VSS. Based on the respective MUX control bits, which are provided by a corresponding bit of the first input data element InDE (e.g., IN₀[7]) and a corresponding bit of the second input data element InDE (e.g., IN₁[7]), the multiplexers 230 can each provide the corresponding signal OUT by performing MAC operations on the signal A, the signal B, the signal SUM, or VSS. In the example where the multiplexer 230 receives the IN₀[7] and IN₁[7] as its MUX controls bits, the multiplexer 230 can provide the signal OUT as W₀[7:0]×IN₀[7]+W₁[7:0]×IN₁[7], which may have 10 bits. In some embodiments, the multi-mode data selector 210 and the configurable adder 220 may operatively form the first (adder) part of the local computing cell 106, and the multiplexers 230 may operatively form the second (multiplexer) part of the local computing cell 106.

A schematic diagram of the configurable adder 220 is also shown in FIG. 3. As illustrated, the configurable adder 220 may have eight full adders, 220A, 220B, 220C, 220D, 220E, 220F, 220G, and 200H serially coupled to one another, with one multiplexer 220M coupled between a first half of the full adders 220A-D and a second half of the full adders 220E-H. Each of the full adders 220A-H may receive and add a corresponding bit of a first signal (e.g., b[0] which is one bit of the D_SEL signal) and a corresponding bit of a second signal (e.g., a[0] which is one bit of the signal A) to output a sum bit (e.g., O₀[0] which is one bit of the signal SUM). Further each of the full adders 220A-H can provide a carry-out bit to a next stage along the chain consisting of the full adders 220A-H and the multiplexer 220M. For example, the full adder 220C can provide a carry-out bit to the full adder 220D. In another example, the full adder 220D can provide a carry-out bit to the multiplexer 220M. In the INT8 example, the multiplexer 220M can provide the carry-out bit provided by the full adder 220D to the next full adder 220E.

Referring next to FIG. 4, similar to FIG. 3, the same schematic diagram of one of the local computing cells 106 of the memory circuit 100 is shown, but the data elements are received or identified as the INT4 data type, in accordance with some embodiments. In the illustrative example of FIG. 4, the local computing cell 106 is coupled to the input circuit 104 to receive a quadruple of the input data elements InDE, each of which has 4 bits, e.g., IN₀[3:0], IN₁[3:0], IN₂[3:0], and IN₃[3:0], and a quadruple of the weight data elements WtDE, each of which has 4 bits, e.g., W₀[3:0], W₁[3:0], W₂[3:0] and W₃[3:0]. Accordingly, it should be appreciated that other local computing cells 106 of the memory circuit 100 can each receive a corresponding quadruple of the input data elements InDE, e.g., IN₄[3:0], IN₅[3:0], IN₆[3:0], and IN₇[3:0], etc., and a corresponding quadruple of the weight data elements WtDE, e.g., W₄[3:0], W₅[3:0], W₆[3:0] and W₇[3:0], etc.

As shown, the local computing cell 106 can receive the W₀[3:0] and W₂[3:0] as the signal B, and the W₁[3:0] and W₃[3:0] as the signal A. The multi-mode data selector 210 can select the signal B and output it as the D_SEL signal (e.g., 8 bits) to the configurable adder 220. The configurable adder 220 can also receive the signal A, and sum the signal A and the D_SEL signal as the signal SUM which may have 10 bits. In the INT4 example, the multiplexer 220M can be configured to provide VSS to the next full adder 220E. That is, the first half of the full adders 220A-D may sum W₀[3:0] and W₂[3:0], and the second half of the full adders 220E-H may sum W₁[3:0] and W₃[3:0]. Each of the multiplexers 230 can receive the signal A, the signal B, the signal SUM, and VSS. Based on the respective MUX control bits, which are provided by a corresponding bit of a first one of the four input data element InDE (e.g., IN₀[3]) and a corresponding bit of a second one of the four input data element InDE (e.g., IN₂[3]), the multiplexers 230 can each provide the corresponding signal OUT by performing MAC operations on the signal A, the signal B, the signal SUM, or VSS. In the example where the multiplexer 230 receives the IN₀[3] and IN₂[3] as its MUX controls bits, the multiplexer 230 can provide the signal OUT as W₀[3:0]×IN₀[3]+W₂[3:0]×IN₂[3], which may have 5 bits, and W₁[3:0]×IN₀[3]+W₃[3:0]×IN₂[3], which may also have 5 bits. In some embodiments, the multi-mode data selector 210 and the configurable adder 220 may operatively form the first (adder) part of the local computing cell 106, and the multiplexers 230 may operatively form the second (multiplexer) part of the local computing cell 106.

Referring then to FIG. 5, similar to FIG. 3, the same schematic diagram of one of the local computing cells 106 of the memory circuit 100 is shown, but the data elements are received or identified as the BF16 data type, in accordance with some embodiments. In the illustrative example of FIG. 5, the local computing cell 106 is coupled to the input circuit 104 to receive one of the input data elements InDE, which has 16 bits, e.g., IN₀, and one of the weight data elements WtDE, which has 16 bits, e.g., W₀. Accordingly, it should be appreciated that other local computing cells 106 of the memory circuit 100 can each receive a corresponding one of the input data elements InDE, e.g., IN₁, etc., and a corresponding one of the weight data elements WtDE, e.g., W₁, etc.

As shown, the local computing cell 106 can receive the mantissa portion of the weight data element W₀ as the signal A, which is expressed as W_{M0}[7:0], and the exponent portion of the weight data element W₀ as the signal B, which is expressed as W_{E0}[7:0]. The multi-mode data selector 210 can select the signal C representing the exponent portion of the input data element IN₀ (e.g., IN_{E0}[7:0]) and output it as the D_SEL signal (e.g., 8 bits) to the configurable adder 220. The configurable adder 220 can also receive the signal A, and sum the signal A and the D_SEL signal as the signal SUM which may have 9 bits. The signal SUM may represent a sum of the exponent portions of the input data element IN₀ and the weight data element W₀, which may be expressed as IN_{E0}[7:0]+W_{E0}[7:0]. Each of the multiplexers 230 can receive the signal B and VSS. Based on the respective MUX control bits, which are provided by a corresponding bit of the mantissa portion of the input data element IN₀ (e.g., IN_{M0}[7]) and VSS, the multiplexers 230 can each provide the corresponding signal OUT by performing a multiplication on the signal B. In the example where the multiplexer 230 receives the IN_{M0}[7] and VSS as its MUX controls bits, the multiplexer 230 can provide the signal OUT as W_{E0}[7:0]×IN_{M0}[7], which may have 10 bits. In some embodiments, the multi-mode data selector 210 and the configurable adder 220 may operatively form the first (adder) part of the local computing cell 106, and the multiplexers 230 may operatively form the second (multiplexer) part of the local computing cell 106.

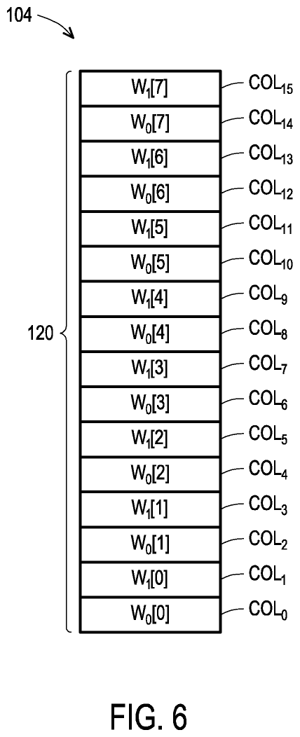

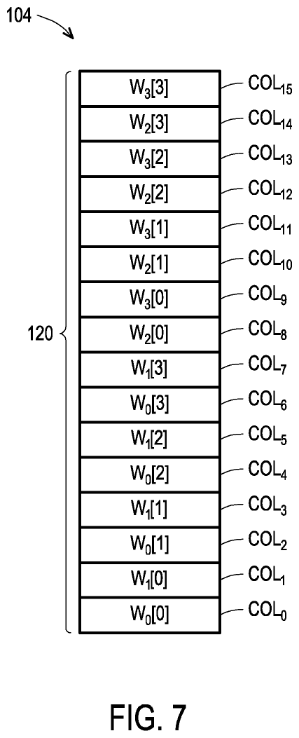

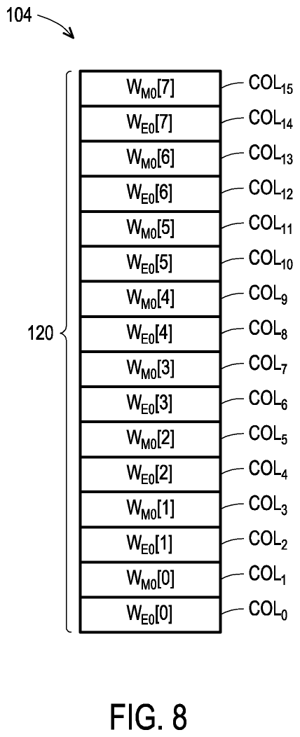

FIGS. 6, 7, and 8 are schematic diagrams illustrating respective configurations of at least a portion of the input circuit 104 (FIG. 1) that is configured to store or provide a number of weight data elements WtDE, in accordance with some embodiments. As a brief overview, in FIG. 6, the input circuit 104 may be configured to provide a pair of weight data elements WtDE, each of which has 8 bits (e.g., when the data elements are provided in the INT8 data type); in FIG. 7, the input circuit 104 may be configured to provide a quadruple of weight data elements WtDE, each of which has 4 bits (e.g., when the data elements are provided in the INT4 data type); and in FIG. 8, the input circuit 104 may be configured to provide one weight data element WtDE, which has 16 bits (e.g., when the data elements are provided in the BF16 data type).

In each of FIGS. 6-8, the input circuit 104 may have 16 storage units (e.g., latches) 120, which can be coupled to different columns included in the memory circuit 102, respectively. For example, the storage units 120 (from the right to left) are coupled to columns, COL₀, COL₁, COL₂, COL₃, COL₄, COL₅, COL₆, COL₇, COL₈, COL₉, COL₁₀, COL₁₁, COL₁₂, COL₁₃, COL₁₄, and COL₁₅, respectively. As a non-limiting example, each of the storage units 120 can be operatively coupled to a bit line and/or bit line bar of the corresponding column. The storage units 120 can each be configured to store one bit of a weight data element WtDE read from a storage element 103 disposed in the corresponding column.

In FIG. 6 (where the data elements are provided in the INT8 data type), the storage units 120, coupled to the even-numbered columns (e.g., COL₀, COL₂, COL₄, etc.), are configured to store 8 bits of a first weight data element W₀ (e.g., W₀[7:0]), respectively; and the storage units 120, coupled to the odd-numbered columns (e.g., COL₁, COL₃, COL₅, etc.), are configured to store 8 bits of a second weight data element W₁ (e.g., W₁[7:0]), respectively.

In FIG. 7 (where the data elements are provided in the INT4 data type), the storage units 120, coupled to the first half of even-numbered columns (e.g., COL₀, COL₂, COL₄, and COL₆), are configured to store 4 bits of a first weight data element W₀ (e.g., W₀[3:0]), respectively; the storage units 120, coupled to the first half of odd-numbered columns (e.g., COL₁, COL₃, COL₅, and COL₇), are configured to store 4 bits of a second weight data element W₁ (e.g., W₀[3:0]), respectively; the storage units 120, coupled to the second half of even-numbered columns (e.g., COL₈, COL₁₀, COL₁₂, and COL₁₄), are configured to store 4 bits of a third weight data element W₂ (e.g., W₂[3:0]), respectively; and the storage units 120, coupled to the second half of odd-numbered columns (e.g., COL₉, COL₁₁, COL₁₃, and COL₁₅), are configured to store 4 bits of a fourth weight data element W₃ (e.g., W₃[3:0]), respectively.

In FIG. 8 (where the data elements are provided in the BF16 data type), the storage units 120, coupled to the even-numbered columns (e.g., COL₀, COL₂, COL₄, etc.), are configured to store 8 bits of the exponent portion of a weight data element W_{E0} (e.g., W_{E0}[7:0]), respectively; and the storage units 120, coupled to the odd-numbered columns (e.g., COL₁, COL₃, COL₅, etc.), are configured to store 8 bits of the mantissa portion of the weight data element W_{M0} (e.g., W_{M0}[7:0]), respectively.

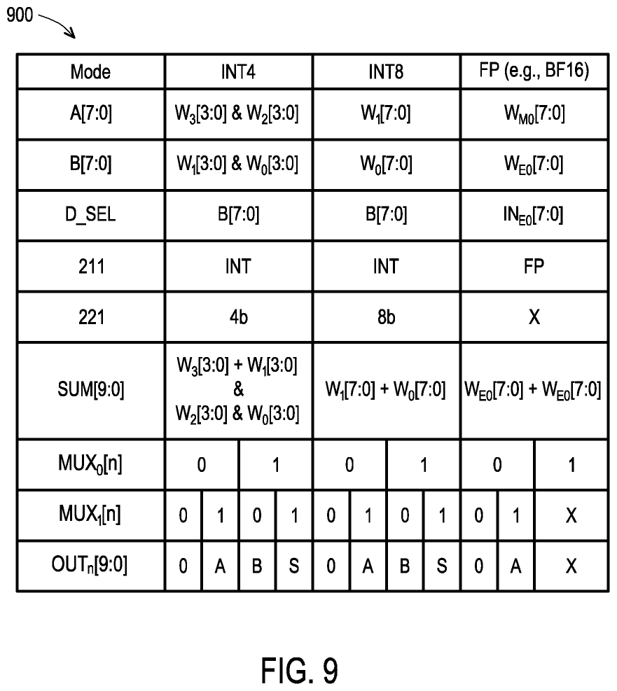

FIG. 9 illustrates a table 900 summarizing various operation modes of the disclosed local computing cell 106/200, in accordance with some embodiments. For example, the table 900 includes three operations modes, which correspond to three data types (e.g., INT8, INT4, and FP16) of the received input data elements InDE and weight data elements WtDE, respectively. Further, the local computing cell 106/200 can process one 16-bit signal, which may include two 8-bit data elements, four 4-bit data elements, or one 16-bit data element, during each operation duration (e.g., one clock cycle). However, it should be understood that the local computing cell 106/200 can be utilized to process any of various other suitable data types, while remaining within the scope of the present disclosure.

As shown, when operating with the INT8 data type, the signal B and the signal A received by the local computing cell may include a first 8-bit weight data element W₀[7:0] and a second 8-bit weight data element W₁[7:0], respectively. Based on the control signal 211 (which indicates the data type as INT), a multi-mode data selector of the local computing cell (e.g., 210) can output the signal B as the signal D_SEL. Based on the control signal 221 (which indicates the integer type as 8b), a configurable adder of the local computing cell (e.g., 220) can utilize all of its eight full adders to sum the signal A and the signal D_SEL so as to provide the signal SUM as W₀[7:0]+W₁[7:0]. Based on the MUX control bits (MUX₀[n] and MUX₁[n]), which correspond to one the 8 bits of a first input data element IN₀[7:0] and one of the 8 bits of a second input data element IN₀[7:0], respectively, each multiplexer of the local computing cell (e.g., 230) can provide the corresponding signal OUT as 0, the signal A, the signal B, or the signal SUM.

When operating with the INT4 data type, the signal B received by the local computing cell may include a first 4-bit weight data element W₀[3:0] and a second 4-bit weight data element W₁[3:0], and the signal A received by the local computing cell may include a third 4-bit weight data element W₂[3:0] and a fourth 4-bit weight data element W₃[3:0]. Based on the control signal 211 (which indicates the data type as INT), a multi-mode data selector of the local computing cell (e.g., 210) can output the signal B as the signal D_SEL. Based on the control signal 221 (which indicates the integer type as 4b), a configurable adder of the local computing cell (e.g., 220) can utilize one half of its eight full adders to sum W₃[3:0] and W₁[3:0], and the other half of the full adders to sum W₂[3:0] and W₀[3:0], so as to provide the signal SUM as W₂[7:0]+W₀[7:0] and W₃[7:0]+W₁[7:0]. Based on the MUX control bits (MUX₀[n] and MUX₁[n]), which correspond to one the 4 bits of a first or third input data element, IN₀[7:0] or IN₂[7:0], and one of the 4 bits of a second or fourth input data element, IN₁[7:0] or IN₃[7:0], respectively, each multiplexer of the local computing cell (e.g., 230) can provide the corresponding signal OUT as 0, the signal A, the signal B, or the signal SUM.

When operating with the BF16 data type, the signal B and the signal A received by the local computing cell may include one 8-bit exponent portion of a weight data element W_{E0}[7:0] and one 8-bit mantissa portion of the weight data element W_{M0}[7:0], respectively. Based on the control signal 211 (which indicates the data type as FP), a multi-mode data selector of the local computing cell (e.g., 210) can output the signal C, which includes one 8-bit exponent portion of an input data element IN_{E0}[7:0], as the signal D_SEL. Based on the control signal 221 (which indicates the integer type as “X”), a configurable adder of the local computing cell (e.g., 220) can utilize all of its eight full adders to sum the signal A and the signal D_SEL so as to provide the signal SUM as W_{E0}[7:0]+IN_{E0}[7:0]. Based on the MUX control bits (MUX₀[n] and MUX₁[n]), which correspond to VSS and one the 8 bits of a mantissa portion of the input data element IN_{M0}[7:0], respectively, each multiplexer of the local computing cell (e.g., 230) can provide the corresponding signal OUT as 0 or the signal A.

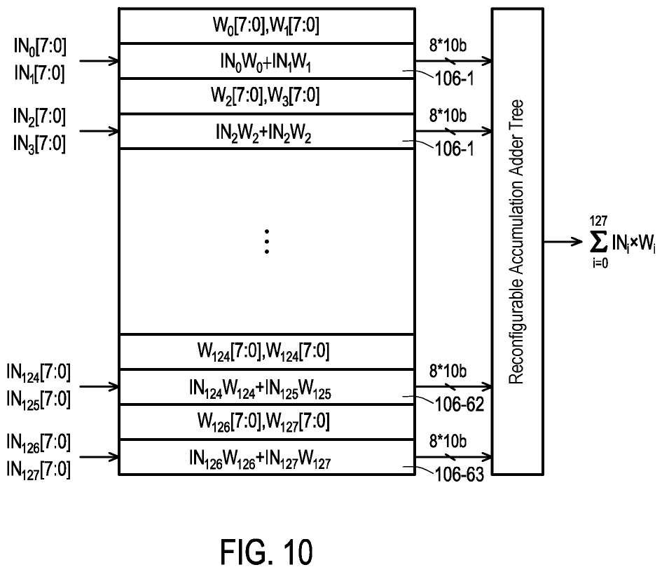

FIGS. 10, 11, and 12 illustrate schematic diagrams of a portion of the memory circuit 100 that process a plural number of input data elements InDE and a plural number of weight data elements WtDE, respectively, in accordance with some embodiments. It should be understood that the schematic diagrams of FIGS. 10-12 are provided for illustrative purposes, and do not limit the scope of the present disclosure.

In the example of FIG. 10, the memory circuit 100 is configured to process 128 input data elements InDE (“IN”) and 128 weight data elements WtDE (“W”), each of which has 8 bits (e.g., the INT8 data type). In accordance with some embodiments, the memory circuit 100 may configure 64 local computing cells (e.g., 106-0, 106-1 . . . 106-63) to receive the data elements from corresponding input circuits 104, respectively, and process MAC operations on these input data elements InDE and weight data elements WtDE. Stated another way, the memory circuit 100 can utilize 64 local computing cells to perform MAC operations on 64 sets of data elements, each set consisting of a first group of 8-bit IN and 8-bit W (e.g., IN₀[7:0] and W₀[7:0]) and a second group of 8-bit IN and 8-bit W (e.g., IN₁[7:0] and W₁[7:0]). After the 64 local computing cells provide respective MAC results, an adder tree can sum these MAC results to provide a final MAC result (e.g., Σᵢ₌₀¹²⁷INᵢ×Wᵢ) through one output channel. In some embodiments, the 64 local computing cells, together with corresponding input circuits 104, may operatively form a CIM array or CIM bank.

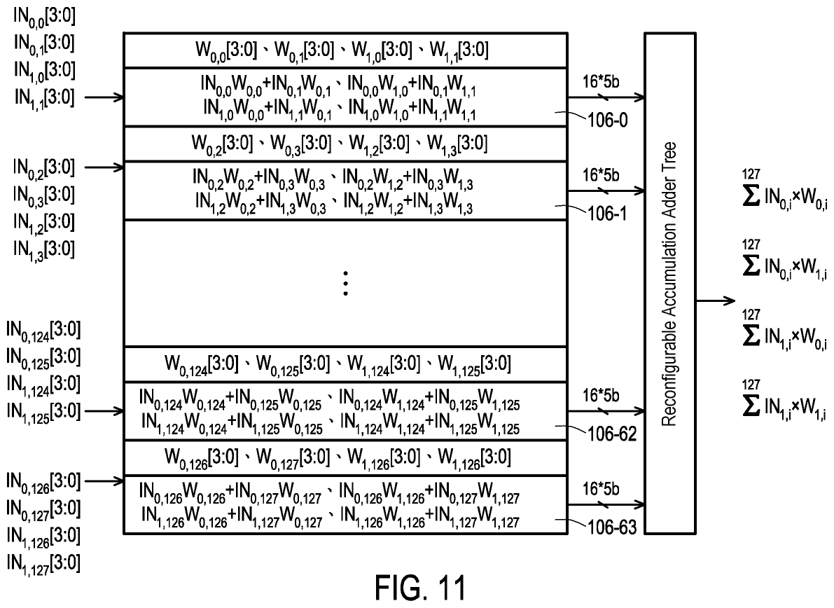

In the example of FIG. 11, the memory circuit 100 is configured to process 256 input data elements InDE (“IN”) and 256 weight data elements WtDE (“W”), each of which has 4 bits (e.g., the INT4 data type). In accordance with some embodiments, the memory circuit 100 may configure 64 local computing cells (e.g., 106-0, 106-1 . . . 106-63) to receive the data elements from corresponding input circuits 104, respectively, and process MAC operations on these input data elements InDE and weight data elements WtDE. Stated another way, the memory circuit 100 can utilize 64 local computing cells to perform MAC operations on 64 sets of data elements, each set consisting of a first group of 4-bit IN and 4-bit W (e.g., IN_{0,0}[3:0] and W_{0,0}[3:0]), a second group of 4-bit IN and 4-bit W (e.g., IN_{0,1}[3:0] and W_{0,1}[3:0]), a third group of 4-bit IN and 4-bit W (e.g., IN_{1,0}[3:0] and W_{1,0}[3:0]), and a fourth group of 4-bit IN and 4-bit W (e.g., IN_{1,i}[3:0] and W_{1,1}[3:0]). After the 64 local computing cells provide respective MAC results, an adder tree can sum these MAC results to provide a final MAC result (e.g., Σᵢ₌₀¹²⁷IN_{0,i}×W_{0,i}, Σᵢ₌₀¹²⁷IN_{0,i}×W_{1,i}, Σᵢ₌₀¹²⁷IN_{1,i}×W_{0,i}, Σᵢ₌₀¹²⁷IN_{1,i}×W_{1,i}) through four output channels, respectively. In some embodiments, the 64 local computing cells, together with corresponding input circuits 104, may operatively form a CIM array or CIM bank.

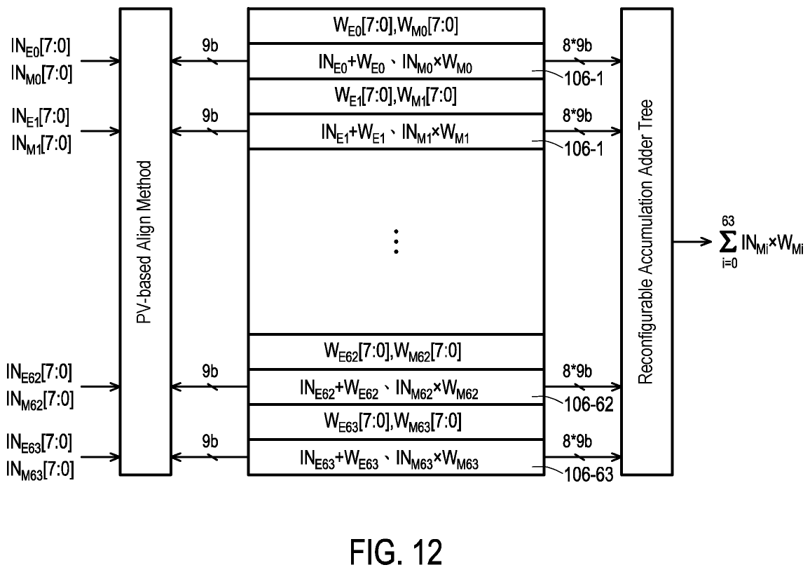

In the example of FIG. 12, the memory circuit 100 is configured to process 64 input data elements InDE (“IN”) and 64 weight data elements WtDE (“W”), each of which includes a mantissa portion of 8 bits and an exponent portion of 8 bits (e.g., the BF16 data type). In accordance with some embodiments, the memory circuit 100 may configure 64 local computing cells (e.g., 106-0, 106-1 . . . 106-63) to receive the data elements from corresponding input circuits 104, respectively, and process MAC operations on these input data elements InDE and weight data elements WtDE. Stated another way, the memory circuit 100 can utilize 64 local computing cells to perform MAC operations on 64 sets of exponent elements, each consisting of one 8-bit weight exponent portion and one 8-bit input exponent portion, and 64 sets of mantissa elements, each consisting of one 8-bit weight mantissa portion and one 8-bit input mantissa portion. After the 64 local computing cells provide respective MAC elements (e.g., IN_{M0}×W_{M0}), an adder tree can sum these MAC elements to provide a final MAC result (e.g., Σᵢ₌₀¹²⁷IN_{Mi}×W_{Mi}) through one output channel. In some embodiments, the 64 local computing cells, together with corresponding input circuits 104, may operatively form a CIM array or CIM bank.

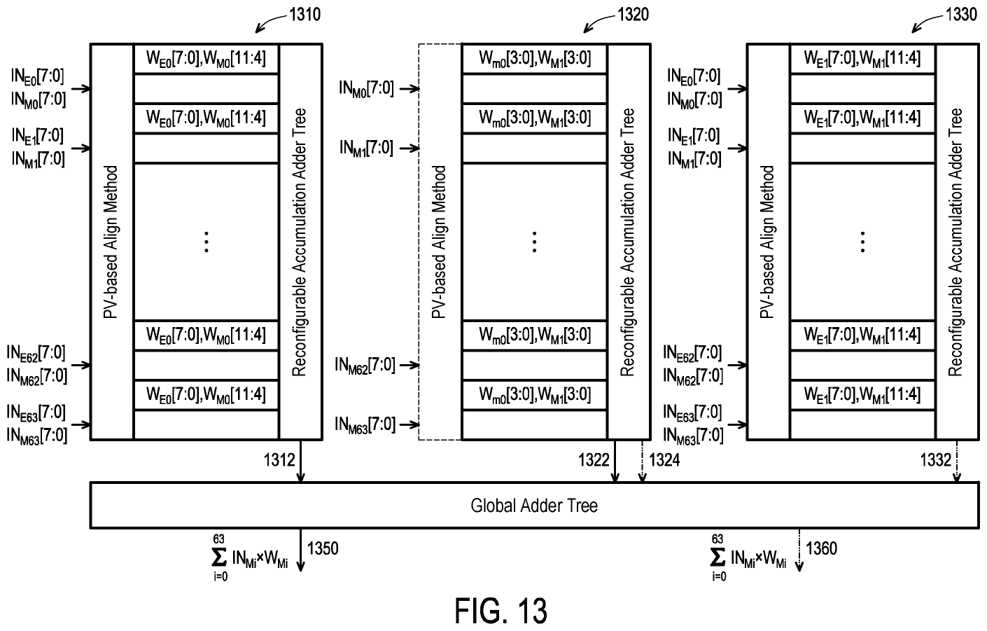

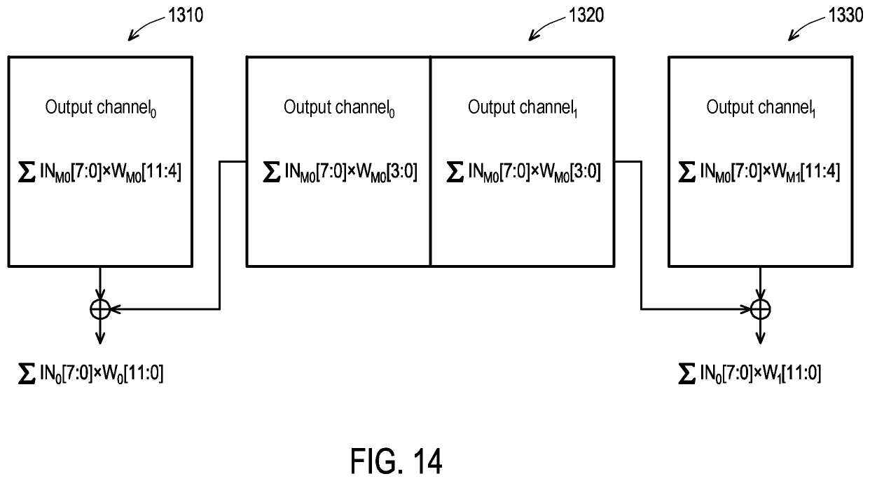

FIG. 13 illustrates a schematic diagram of a portion of the memory circuit 100 that process a plural number of input data elements InDE and a plural number of weight data elements WtDE, each of which is provided as the FP16 data type, in accordance with some embodiments. That is, each of the data elements InDE/WtDE includes a mantissa portion with 10 bits and an exponent portion with 5 bits. FIG. 14 illustrates an equivalent block diagram of the schematic diagram of FIG. 13.

In some embodiments, the memory circuit 100 may configure three CIM banks, 1310, 1320, and 1330 to perform MAC operations on the data elements InDE/WtDE that are provided in the FP16 data type. In the example of FIG. 13, there are 64 input data elements InDE provided in the FP 16 data type (IN₀, IN₁ . . . IN₆₃), 64 first weight data elements WtDE (“W₀”) provided in the FP 16 data type, and 64 second weight data elements WtDE (“W₁”) provided in the FP 16 data type. To process more than 8 bits using the disclosed memory circuit 100 (e.g., the mantissa portion of the FP16 data type), the mantissa portion of each first weight data element W_{M0} can be grouped into a first group (e.g., W_{M0}[11:4]) and a second group (e.g., W_{M0}[3:0]), and the mantissa portion of each second weight data element W_{M1} can be grouped into a first group (e.g., W_{M1}[11:4]) and a second group (e.g., W_{M1}[3:0]).

The CIM bank 1310 can have 64 local computing cells to provide, through an adder tree, a first MAC result 1312 based on the first group of the mantissa portions of the first weight data element W_{M0} (e.g., W_{M0}[11:4]), exponent portions of the first weight data element W_{M0} (e.g., W_{E0}[7:0]), and the input data elements InDE (e.g., IN₀, IN₁ . . . IN₆₃). The CIM bank 1320 can have 64 local computing cells to provide, through an adder tree, a second MAC result 1322 based on the second group of the mantissa portions of first weight data element W_{M0} (e.g., W_{M0}[3:0]) and the input data elements InDE (e.g., IN₀, IN₁ . . . IN₆₃), and a third MAC result 1324 based on the second group of the mantissa portions of second weight data element W_{M1} (e.g., W_{M1}[3:0]) and the input data elements InDE (e.g., IN₀, IN₁ . . . IN₆₃). The CIM bank 1330 can have 64 local computing cells to provide, through an adder tree, a fourth MAC result 1332 based on the first group of the mantissa portions of the second weight data element W_{M1} (e.g., W_{M1}[11:4]), exponent portions of the second weight data element W_{M1} (e.g., W_{E1}[7:0]), and the input data elements InDE (e.g., IN₀, IN₁ . . . IN₆₃). In some embodiments, the memory circuit 100 can include a global adder tree to sum the MAC results 1312 and 1322 as MAC result 1350 and provide it through a first output channel, and sum the MAC results 1324 and 1332 as MAC result 1360 and provide it through a second output channel. Specifically, the CIM banks 1310 and 1330 may be configured similarly to the operation mode when processing the BF16 data type (e.g., FIGS. 5 and 12).

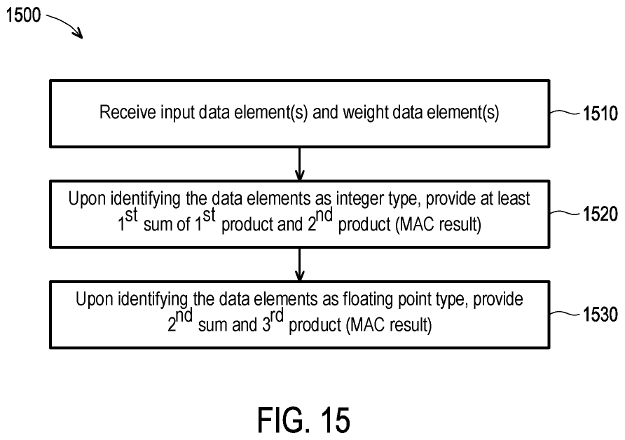

FIG. 15 illustrates a flow chart of an example method 1500 for operating a compute-in-memory circuit, in accordance with some embodiments. For example, at least some of the operations of the method 1500 can be performed to cause the memory circuit 100 (FIG. 1) to generate a number of MAC results. Thus, in the following discussion of the methods 1500, the reference numerals used in the figures above (e.g., FIGS. 1-12) may be reused. It is noted that the method 1500 is merely an example and is not intended to limit the present disclosure. Accordingly, it is understood that additional operations may be provided before, during, and after the method 1500 of FIG. 15, and that some other operations may only be briefly described herein.

The method 1500 starts with operations 1510 in which a plurality of input data elements InDE and a plurality of weight data elements WtDE are received through a memory device. In some embodiments, the input data elements InDE may be received by a memory device (e.g., 102 of FIG. 1) and the weight data elements WtDE may be stored in respective storage elements (e.g., 103) of the memory device. In an example where 128 input data elements InDE and 128 weight data elements WtDE are provided, the input data elements InDE may be IN₀, IN₁, IN₂ . . . IN₁₂₇, respectively, and the weight data elements WtDE may be W₀, W₁, W₂ . . . W₁₂₇, respectively.

In various embodiments of the present disclosure, the input data elements InDE and the weight data elements WtDE can be provided or otherwise identified in various data types such as, for example, the INT8 data type, the INT4 data type, the BF16 data type, the FP data type, etc. Upon identifying the data type of the input data elements InDE and the weight data elements WtDE, the memory circuit 100 can configure the same hardware components (e.g., the local computing cells 106) in a respective mode to process (e.g., MAC) the data elements. For example, in response to identifying that the data type is an integer type (e.g., the INT8 data type, the INT4 data type, etc.), the method 1500 may proceed to operation 1520; and in response to identifying that the data type is a floating point type (e.g., the BF16 data type, the FP16 data type, etc.), the method 1500 may proceed to operation 1530.

In operation 1520, each of the local computing cells 106 can provide at least a first sum of a first product and a second product. Further, the local computing cell 106 can provide the respective first sum when the integer type is the INT8 data type. In some embodiments (referring to FIG. 3, for example), the first product can be one of the input data elements (e.g., IN₀) times a corresponding one of the weight data elements (e.g., W₀), and the second product can be another one of the input data elements (e.g., IN₁) times a corresponding one of the weight data elements (e.g., W₁). When the integer type is the INT4 data type (referring to FIG. 4, for example), in addition to the first sum (e.g., IN₀×W₀+IN₂×W₂), the local computing cell 106 can provide additional sums (e.g., IN₀×W₁+IN₂×W₃, IN₁×W₀+IN₃×W₂, and IN₁×W₁+IN₃×W₃). When configured in the mode of processing the integer data type, such a sum may sometimes be referred to as a partial MAC result. After each of the local computing cells 106 provides its respective one or more partial MAC results, the memory circuit 100 can sum them up with an adder tree (e.g., 108 of FIG. 1) to provide a final MAC result (PS).

In operation 1530, each of the local computing cells 106 can provide at least a second sum and a third product. In some embodiments (referring to FIG. 5, for example), the second sum can be an exponent portion of one of the input data elements (e.g., IN_{E0}) plus an exponent portion of a corresponding one of the weight data elements (e.g., W_{E0}), and the third product can be a mantissa portion of the input data element (e.g., IN_{M0}) times a mantissa portion of the weight data element (e.g., IN_{M0}). When configured in the mode of processing the floating point data type, such a exponent sum and mantissa product may sometimes be referred to as a pair of MAC elements. After each of the local computing cells 106 provides its respective pair of MAC elements (e.g., the mantissa products), the memory circuit 100 can sum them up with an adder tree (e.g., 108 of FIG. 1) to provide a final MAC result (PS).

In one aspect of the present disclosure, a compute-in-memory (CIM) circuit is disclosed. The CIM circuit includes an input circuit configured to receive a first number of input data elements and the first number of weight data elements. The CIM circuit includes a second number of local computing cells operatively coupled to the input circuit. Each of the local computing cells is configured to provide, in response to identifying that the input data elements and weight data elements are provided as a first data type, at least a first sum, the first sum including (i) a first product of a first one of the input data elements and a first one of the weight data elements; and (ii) a second product of a second one of the input data elements and a second one of the weight data elements. Each of the local computing cells is configured to provide, in response to identifying that the input data elements and weight data elements are provided as a second data type, (i) a second sum of a first portion of a third one of the input data elements and a first portion of a third one of the weight data elements; and (ii) a third product of a second portion of the third input data element and a second portion of the third weight data element.

In another aspect of the present disclosure, a compute-in-memory (CIM) circuit is disclosed. The CIM circuit includes a first local computing cell operatively coupled to a first number of input data elements and the first number of weight data elements, the first local computing cell comprising a first part and a second part operatively coupled to each other. The first part is configured to provide a first sum of the first number of weight data elements, in response to identifying that the input data elements and the weight data elements are provided as an integer data type, which causes the second part to (i) select one of the first number of weight data elements, the first sum, or a fixed logic state; and (ii) based on the first number of input data elements, provide a plurality of first multiply-accumulate (MAC) results of the first number of input data elements and the first number of weight data elements. The first part is configured to provide a second sum of respective exponent portions of the first number of input data elements and the first number of weight data elements, in response to identifying that the input data elements and the weight data elements are provided as a floating point data type, which causes the second part to (i) select a mantissa portion of the first number of weight data elements; and (ii) based on a mantissa portion of the first number of input data elements, provide a plurality of first products of the respective mantissa portions of the first number of input data elements and the first number of weight data elements.

In yet another aspect of the present disclosure, a method for operating a compute-in-memory (CIM) circuit is disclosed. The method includes receiving, through a memory device, a plurality of input data elements and a plurality of weight data elements. The method includes providing, in response to identifying that the input data elements and weight data elements are provided as an integer data type, at least a first sum, wherein the first sum includes (i) a first product of a first one of the input data elements and a first one of the weight data elements; and (ii) a second product of a second one of the input data elements and a second one of the weight data elements. The method includes providing, in response to identifying that the input data elements and weight data elements are provided as a floating point data type, (i) a second sum of an exponent portion of a third one of the input data elements and an exponent portion of a third one of the weight data elements; and (ii) a third product of a second portion of the third input data element and a second portion of the third weight data element.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A compute-in-memory (CIM) circuit, comprising:
an input circuit configured to receive a first number of input data elements and the first number of weight data elements;
a second number of local computing cells operatively coupled to the input circuit, wherein each of the local computing cells is configured to:
provide, in response to identifying that the input data elements and weight data elements are provided as a first data type, at least a first sum, the first sum including (i) a first product of a first one of the input data elements and a first one of the weight data elements; and
(ii) a second product of a second one of the input data elements and a second one of the weight data elements; and
provide, in response to identifying that the input data elements and weight data elements are provided as a second data type, (i) a second sum of a first portion of a third one of the input data elements and a first portion of a third one of the weight data elements; and (ii) a third product of a second portion of the third input data element and a second portion of the third weight data element.

2. The circuit of claim 1, wherein the second number is one half of, one fourth of, or equal to the first number.

3. The circuit of claim 1, wherein the first data type includes one of: an INT4 data type or an INT8 data type, and the second data type includes one of: an FP16 data type or a BF16 data type.

4. The circuit of claim 3, wherein the first portions include exponent portions of the third input data element and the third weight data element, respectively, and the second portions include mantissa portions of the third input data element and the third weight data element, respectively.

5. The circuit of claim 1, wherein each of the local computing cells is further configured to:
provide, in response to identifying that the input data elements and weight data elements are provided as the first data type and each having 8 bits, the first sum.

6. The circuit of claim 1, wherein each of the local computing cells is further configured to:
provide, in response to identifying that the input data elements and weight data elements are provided as the first data type and each having 4 bits, the first sum and further a third sum, the third sum including: (i) a fourth product of a fifth one of the input data elements and a fifth one of the weight data elements; and (ii) a fifth product of a sixth one of the input data elements and a sixth one of the weight data elements.

7. The circuit of claim 1, wherein each of the local computing cells comprises:
a multi-mode data selector;
a configurable adder; and
a plurality of multiplexers.

8. The circuit of claim 7, wherein the multi-mode data selector is configured to:
select the first weight data element in response to identifying that the input data elements and weight data elements are provided as the first data type; and
select the first portion of the third input data element in response to identifying that the input data elements and weight data elements are provided as the second data type.

9. The circuit of claim 7, wherein the configurable adder is configured to:
sum at least the first weight data element and the second weight data element in response to identifying that the input data elements and weight data elements are provided as the first data type; and
sum the first portion of the third input data element and the first portion of the third weight data element in response to identifying that the input data elements and weight data elements are provided as the second data type.

10. The circuit of claim 7, wherein, in response to identifying that the input data elements and weight data elements are provided as the first data type, each of the plurality of multiplexers is configured to:
receive a corresponding bit of the first input data element and a corresponding bit of the second input data element; and
provide, based on a logic combination of the corresponding bit of the first input data element and the corresponding bit of the second input data element, a result of the first sum.

11. A compute-in-memory (CIM) circuit, comprising:
a first local computing cell operatively coupled to a first number of input data elements and the first number of weight data elements, the first local computing cell comprising a first part and a second part operatively coupled to each other;
wherein the first part is configured to provide a first sum of the first number of weight data elements, in response to identifying that the input data elements and the weight data elements are provided as an integer data type, which causes the second part to (i) select one of the first number of weight data elements, the first sum, or a fixed logic state; and (ii) based on the first number of input data elements, provide a plurality of first multiply-accumulate (MAC) results of the first number of input data elements and the first number of weight data elements; and
wherein the first part is configured to provide a second sum of respective exponent portions of the first number of input data elements and the first number of weight data elements, in response to identifying that the input data elements and the weight data elements are provided as a floating point data type, which causes the second part to (i) select a mantissa portion of the first number of weight data elements; and (ii) based on a mantissa portion of the first number of input data elements, provide a plurality of first products of the respective mantissa portions of the first number of input data elements and the first number of weight data elements.

12. The circuit of claim 11, further comprising:
a second local computing cell operatively coupled to a second number of input data elements and the second number of weight data elements, the second local computing cell comprising a third part and a fourth part operatively coupled to each other;
wherein the third part is configured to provide a third sum of the second number of weight data elements, in response to identifying that the input data elements and the weight data elements are provided as the integer data type, which causes the fourth part to (i) select one of the second number of weight data elements, the third sum, or the fixed logic state; and (ii) based on the second number of input data elements, provide a plurality of second MAC results of the second number of input data elements and the second number of weight data elements; and
wherein the fourth part is configured to provide a fourth sum of respective exponent portions of the second number of input data elements and the second number of weight data elements, in response to identifying that the input data elements and the weight data elements are provided as the floating point data type, which causes the fourth part to (i) select a mantissa portion of the second number of weight data elements; and (ii) based on a mantissa portion of the second number of input data elements, provide a plurality of second products of the respective mantissa portions of the second number of input data elements and the second number of weight data elements.

13. The circuit of claim 12, wherein the first number is equal to the second number, which is equal to 2 or 4 when the input data elements and the weight data elements are provided as the integer data type.

14. The circuit of claim 12, wherein the first number is equal to the second number, which is equal to 1 when the input data elements and the weight data elements are provided as the floating point data type.

15. The circuit of claim 11, wherein the first part comprises a multi-mode data selector and a configurable adder, and the second part comprises a plurality of multiplexers.

16. The circuit of claim 15, wherein the multi-mode data selector is configured to:
select one of the first number of weight data elements and provide the selected one of the first number of weight data elements to the configurable adder for generating the first sum, in response to identifying that the input data elements and the weight data elements are provided as the integer data type; and
select the exponent portion of the first number of input data elements and provide the exponent portion of the first number of input data elements to the configurable adder for generating the second sum, in response to identifying that the input data elements and the weight data elements are provided as the floating point data type.

17. The circuit of claim 16, wherein each of the plurality of multiplexers is configured to:
receive corresponding bits of the first number of input data elements; and
provide, based on the received bits, a corresponding one of the first MAC results.

18. The circuit of claim 16, wherein each of the plurality of multiplexers is configured to:
receive a corresponding bit of the mantissa portion of the first number of input data elements; and
provide, based on the corresponding bit, a corresponding one of the first products.

19. A method for operating a compute-in-memory (CIM) circuit, comprising:
receiving, through a memory device, a plurality of input data elements and a plurality of weight data elements;
providing, in response to identifying that the input data elements and weight data elements are provided as an integer data type, at least a first sum, wherein the first sum includes (i) a first product of a first one of the input data elements and a first one of the weight data elements; and (ii) a second product of a second one of the input data elements and a second one of the weight data elements; and
providing, in response to identifying that the input data elements and weight data elements are provided as a floating point data type, (i) a second sum of an exponent portion of a third one of the input data elements and an exponent portion of a third one of the weight data elements; and (ii) a third product of a second portion of the third input data element and a second portion of the third weight data element.

20. The method of claim 19, the integer data type includes one of: an INT4 data type or an INT8 data type, and the floating point data type includes one of: an FP16 data type or a BF16 data type.

21. The circuit of claim 7, wherein, in response to identifying that the input data elements and weight data elements are provided as the second data type, each of the plurality of multiplexers is configured to:
receive a corresponding bit of the second portion of the third input data element; and
provide, based on a logic combination of the corresponding bit of the second portion of the third input data element and a fixed logic state, a result of the third product.
